(19) United States
(12) Patent Application Publication
(10) Pub. No.: US 2013/0027805 A1
(43) Pub. Date: Jan. 31, 2013

(54) INFORMATION PROCESSING APPARATUS AND DISK DEVICE CONTROL METHOD

(71) Applicant: Toshikazu Mukaiyama, Nishitama-gun (JP)

(72) Inventor: Toshikazu Mukaiyama, Nishitama-gun (JP)

(73) Assignee: KABUSHIKI KAISHA TOSHIBA, Tokyo (JP)

(21) Appl. No.: 13/488,115

(22) Filed: Jun. 4, 2012

(30) Foreign Application Priority Data
Jul. 29, 2011 (JP) 2011-167744

(51) Int. Cl. G11B 15/46

(52) U.S. Cl. 360/73.01; G9B/15.054

(57) ABSTRACT

According to one embodiment, an information processing apparatus includes: a main unit; a first disk device provided in the main unit; a second disk device provided in the main unit; an acceleration sensor provided in the main unit and detecting an acceleration; a setting module for setting whether to execute a disk protection processing for at least one of the first disk device and the second disk device or not; and a controller for executing the processing on the disk device for which the execution of the processing is set by the setting module, when an acceleration is detected by the acceleration sensor.

### CROSS REFERENCE TO RELATED APPLICATION(S)

The application is based upon and claims the benefit of priority from Japanese Patent Application No. 2011-167744 filed on Jul. 29, 2011, the entire contents of which are incorporated herein by reference.

### BACKGROUND

1. Field

An embodiment of the present invention relates to an information processing apparatus such as a personal computer and a disk device control method applied to the apparatus.

2. Description of the Related Art

In recent years, information processing apparatuses such as personal computers have been downsized and it is becoming more and more frequent to carry an information processing apparatus for mobile use. Many of such personal computers are provided with a magnetic disk device such as a hard disk drive (HDD), and this magnetic disk device is sensitive to vibrations and shocks. That is, if a magnetic disk device is exposed to a vibration or a shock when it is writing data onto a magnetic disk by using a magnetic head or is reading data written on the magnetic disk by using the magnetic head, there is a possibility that the magnetic head and the magnetic disk come into contact with each other to cause breakage.

With such circumstances as the background, a technology is disclosed in which in an electronic apparatus having a plurality of disk devices, at least one disk device is made to transition to a shock protection state and the other disk device performs recording and reproduction.

In the above configuration, by alternately writing the same data into a plurality of disk devices, the data can be recovered even when a failure occurs in one disk device.

On the other hand, when a plurality of disk devices are provided, there is a user demand that different data be stored in each disk device to separate the use of the disk devices. That is, data to be protected is stored in one disk device and data that maybe damaged is stored in the other, whereby a usage pattern is realized such that reading and writing are continued without a transition to the shock protection state even when a vibration occurs.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view showing the appearance of an information processing apparatus according to an embodiment of the present invention;

FIG. 2 is a block diagram showing the system configuration of the information processing apparatus of the embodiment;

FIG. 3 is a view showing an example of an HDD protection setting screen of the information processing apparatus of the embodiment;

FIG. 4 is a flowchart showing event notifications of HDD protection processing executed by the information processing apparatus of the embodiment; and

FIG. 5 is a flowchart explaining the procedure of the HDD protection processing executed by the information processing apparatus of the embodiment.

### DETAILED DESCRIPTION

According to one embodiment, an information processing apparatus includes: a main unit; a first disk device provided in the main unit; a second disk device provided in the main unit; an acceleration sensor provided in the main unit and detecting an acceleration; a setting module configured to set whether to execute a disk protection processing for at least one of the first disk device and the second disk device or not; and a controller configured to execute the processing on the disk device for which the execution of the processing is set by the setting module, when an acceleration is detected by the acceleration sensor.

Hereinafter, an embodiment of the present invention will be described with reference to the drawings.

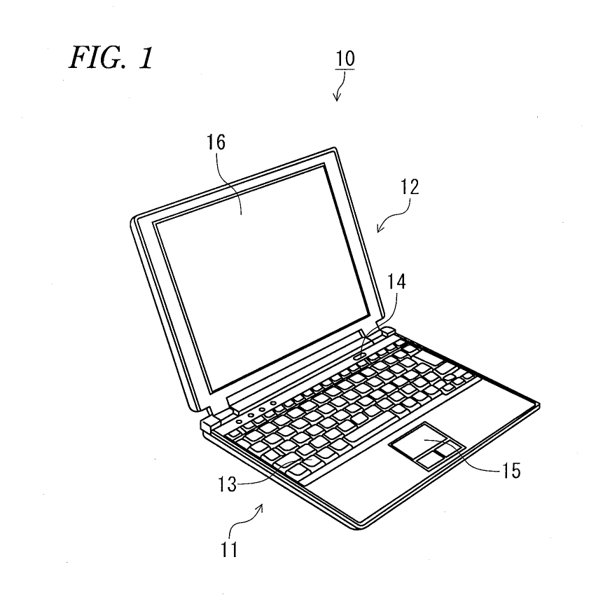

First, referring to FIG. 1, the structure of an information processing apparatus according to the embodiment of the present invention will be described. This information processing apparatus is implemented, for example, as a portable notebook personal computer 10 that can be driven on a battery. FIG. 1 is a perspective view, viewed from the front side, of the computer 10 with a display unit being opened. The computer 10 includes a computer main unit 11 and the display unit 12. The display unit 12 incorporates a display device constituted by an LCD (liquid crystal display) 16.

The display unit 12 is supported by the computer main unit 11, and is attached to the computer main unit 11 so as to be pivotable between an open position where the upper surface of the computer main unit 11 is exposed and a closed position where the upper surface of the computer main unit 11 is covered by the display unit 12. The computer main unit 11 has a thin box-shaped housing, and on the upper surface thereof, a keyboard 13, a touch pad 15 and a power button 14 for powering on and off the computer 10 are disposed.

The computer 10 has an operating state and a power saving state. The power saving state is a state in which nearly all the devices except some specific devices such as a main memory are powered off.

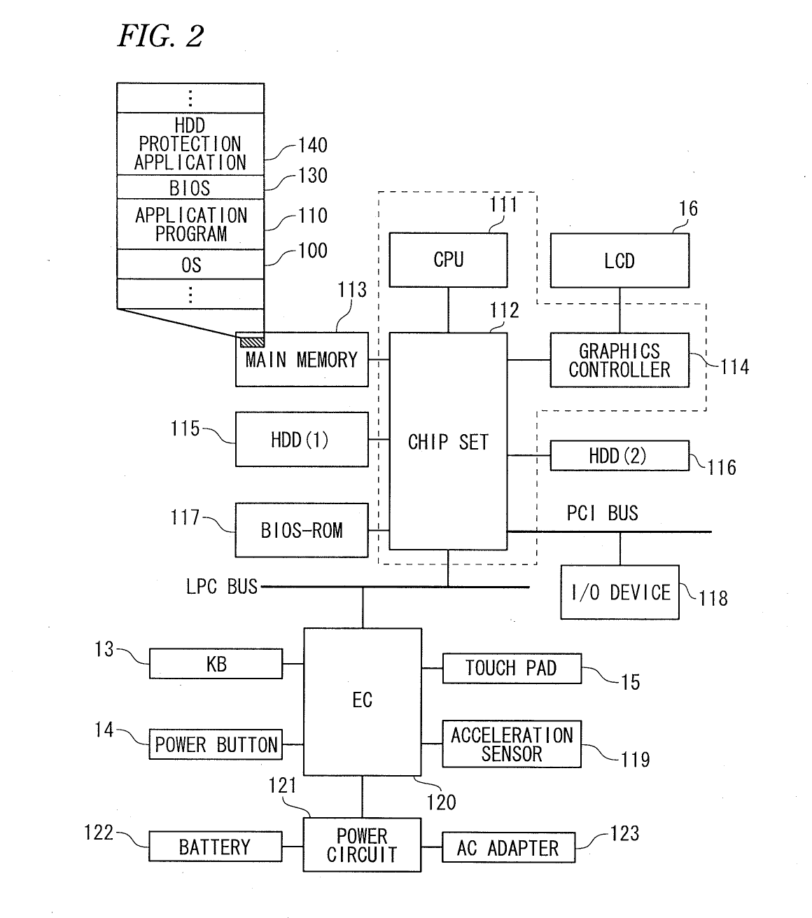

FIG. 2 shows the system configuration of the computer 10. The computer 10 includes: a CPU 111; a chip set 112; a main memory 113; a graphics controller 114; a hard disk drive (HDD) 115; an HDD(2) 116; a BIOS-ROM 117; an I/O device 118 connected to a PCI bus; an acceleration sensor 119; an embedded controller (EC) 120; and a power circuit 121.

In the present embodiment, the HDD(1) 115 and the HDD(2) 116 are provided as disk devices. As the data stored in the two HDDs, for example, important data to be protected is stored on the HDD(1) 115, and data that may be broken is stored on the HDD(2) 116.

The CPU 111 is a processor that controls the operation of each component of the computer 10. The CPU 111 executes various pieces of software loaded into the main memory 113 from the HDD(1) 115 or the HDD(2) 116 such as an operating system (OS) 100 and an application program 110. The CPU 111 also executes a BIOS (basic input output system) 130 stored in the BIOS-ROM 117 which is a nonvolatile memory. The BIOS 130 is a system program for hardware control.

In the present embodiment, by executing an HDD protection application 140, HDD protection processing on the HDD(1) 115 and the HDD(2) 116 is executed. An example of the HDD protection processing is a processing of temporarily stopping data reading and writing between a cache and a disk and retracting the head to a ramp situated in a region outside the disk. The operation of the HDD protection application 140 will be described later.

The chip set 112 is connected to the local bus of the CPU 111, a PCI (peripheral component interconnect) bus and an LPC (low pin count) bus. The chip set 112 has the function of executing communication with the graphics controller 114. Further, the chip set 112 incorporates a memory controller that controls the main memory 113. The graphics controller 114 is a display controller that controls the LCD 16 used as the display monitor of the computer 10.

The embedded controller (EC) 120 is a controller including the function of executing power management of the computer, and is implemented as a one-chip microcomputer also incorporating a keyboard controller function to control the keyboard (KB) 13, the touch pad 15 and the like. The EC 120 powers on and off the computer 10 in response to an operation of the power button switch 14 by the user in cooperation with the power circuit 121. The power circuit 121 generates system power to be supplied to each component of the computer 10, by using a battery 122 incorporated in the computer main unit 11 or external power supplied through an AC adapter 123.

While the present invention is described as a structure in which the CPU 111, the chip set 112 and the graphics controller 114 are physically separated in the above, it is not limited to this structure. For example, a structure may be adopted in which the three are physically united or in which any of the three are united. For example, a structure may be adopted in which a component into which the CPU 111 and the graphics controller 114 are united has the interface with the main memory 113 and the graphics controller 114 and the chip set 112 is separately provided.

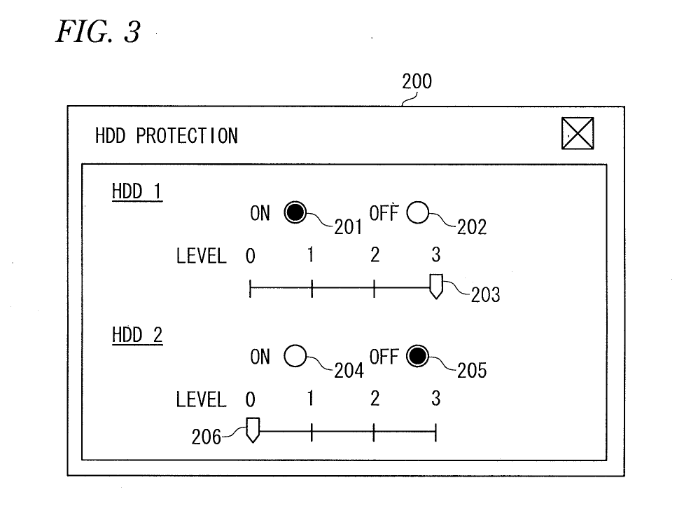

FIG. 3 is a view showing an example of an HDD protection setting screen 200 of the information processing apparatus of the present embodiment. The HDD protection setting screen 200 is outputted by the CPU 111 executing the HDD protection application 140. The HDD protection setting screen 200 may be set to be outputted by a user operation or may be set to be outputted at the time of the initial activation.

The HDD protection setting screen 200 will be described. As shown in FIG. 3, on the setting screen 200, the HDD protection processing on the HDD(1) 115 (shown as HDD1) and the HDD(2) 116 (shown as HDD2) can be set. For the HDD(1) 115, the following are displayed: a button 201 to set the HDD protection processing on the HDD(1) 115 to ON; a button 202 to set it to OFF; and an icon 203 to set the sensitivity level when the HDD protection processing is set to ON. Here, setting the HDD protection processing to ON is setting the disk protection function to operative. Moreover, setting the HDD protection processing to OFF is setting the disk protection function to inoperative.

For the HDD(2) 116, the following are displayed: a button 204 to set the HDD protection processing on the HDD(2) 116 to ON; a button 205 to set it to OFF; and an icon 206 to set the sensitivity level when the HDD protection processing is set to ON.

The sensitivity level is set to four levels of level 0 to level 3. The sensitivity level is defined based on accelerations X1 to X4. When accelerations equal to or higher than the accelerations X1 to X4 corresponding to the sensitivity levels, respectively, are detected, the HDD protection processing is executed. In other words, the threshold values at the sensitivity levels 0 to 3 are the accelerations X1 to X4, respectively, and when accelerations higher than the threshold values are detected, the HDD protection processing is executed. The relative relationship among the accelerations X1 to X4 is that the acceleration X1 is the highest and the acceleration X4 is the lowest. The acceleration decreases in the order of the acceleration X1 to the acceleration X4.

At the level 0, when an acceleration equal to or higher than the acceleration X1 is detected, the HDD protection processing is executed. At the level 1, when an acceleration equal to or higher than the acceleration X2 is detected, the HDD protection processing is executed. At the level 2, when an acceleration equal to or higher than the acceleration X3 is detected, the HDD protection processing is executed. At the level 3, when an acceleration equal to or higher than the acceleration X4 is detected, the HDD protection processing is executed.

That is, when the sensitivity level is set to the level 0, the HDD protection processing is not executed even when the HDD is exposed to a comparatively large vibration, and reading and writing of the HDD are continued. Consequently, for example, when music is played back while the user is carrying the computer 10, he/she can listen to it without the playback being stopped, which leads to usability improvement. On the other hand, when the sensitivity level is set to the level 3, the HDD protection processing is executed even when a slight vibration is detected, and reading and writing of the HDD are stopped, so that data can be more reliably protected.

In the present embodiment, it is assumed that the sensitivity level is set as shown in FIG. 3. That is, for the HDD(1) 115, the HDD protection processing is set to ON and the sensitivity level is set to the level 3, and for the HDD(2) 116, the HDD protection processing is set to OFF. The HDD protection setting information is stored in a storage device such as the main memory 113.

For example, when the acceleration X3 is detected in such a setting, the HDD protection processing is executed on the HDD(1) 115, and the HDD protection processing is not executed on the HDD(2) 116. Here, important data, programs and applications are stored on the HDD(1) 115, and data that may be broken is stored on the HDD(2) 116. Examples of the data to be stored in the HDD(1) 115 include backup data of data stored in the OS 110 and the HDD(2) 116. Examples of the data stored in the HDD(2) 116 include a copy of music data stored in the HDD(1) 115.

When data is stored in the HDD(1) 115 and the HDD(2) 116 as described above, the following usage pattern of the computer 10 is realized: When music data is played back while the user is carrying the computer 10, that is, under a use condition where the computer 10 vibrates, data on the HDD(1) 115 where backup data is stored is protected by executing the HDD protection processing and stopping reading and writing, whereas the playback of the music data is not stopped because reading from the HDD(2) 116 is continued. Thus, ensuring of data protection and a usage pattern desired by the user are both realized.

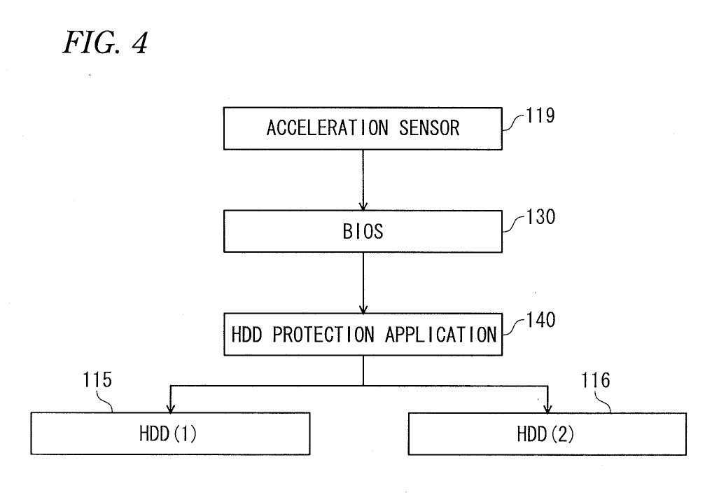

FIG. 4 is a flowchart showing event notifications of the HDD protection processing executed by the information processing apparatus of the present embodiment. First, a vibration detection event detected by the acceleration sensor 119 is notified to the BIOS 130. This vibration detection event includes acceleration data. Then, the BIOS 130 notifies the vibration detection event to the HDD protection application 140. The HDD protection application 140 outputs a control signal to the HDD(1) 115 and the HDD(2) 116 based on the HDD protection setting.

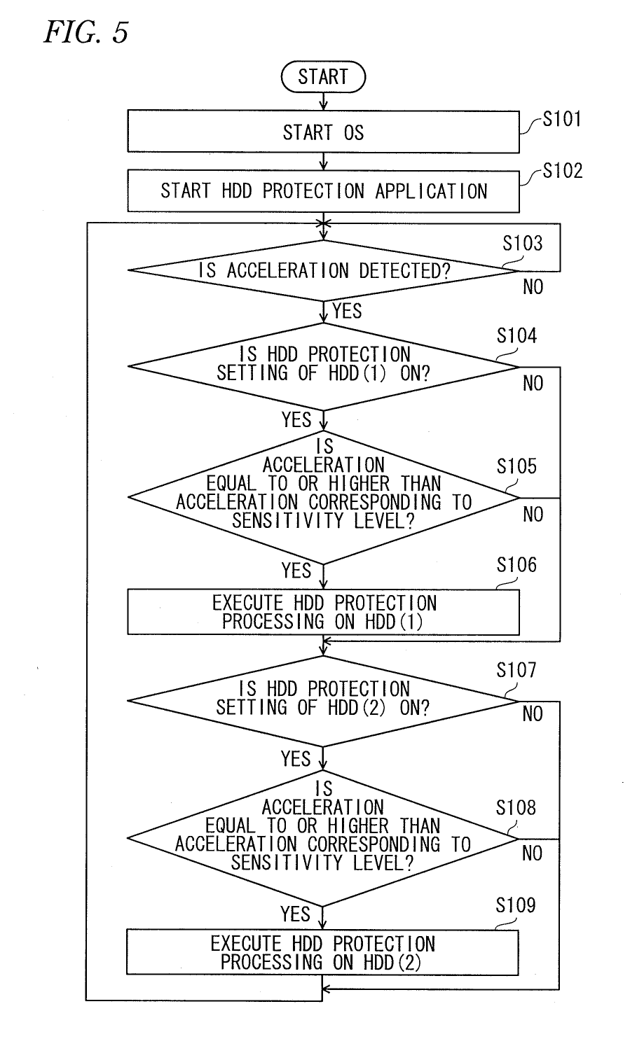

FIG. 5 is a flowchart explaining the procedure of the HDD protection processing executed by the information processing apparatus of the present embodiment.

First, this HDD protection processing is implemented by the CPU 111 executing the HDD protection application 140.

First, when the power button 14 is pressed while the power of the computer 10 is OFF, the OS 100 is started (step S101). Then, the HDD protection application 140 is started (step S102). The operation described below is implemented by the CPU 111 executing the HDD protection application 140.

The CPU 111 determines whether an acceleration is detected by the acceleration sensor 119 or not (step S103). When the CPU 111 determines that no acceleration is detected as a result of the determination at step S103 (No of step S103), the process shifts to step S103. On the other hand, when the CPU 111 determines that an acceleration is detected as a result of the determination at step S103 (Yes of step S103), then, the CPU 111 determines whether the HDD protection setting of the HDD(1) 115 is set to ON or not (step S104). When the CPU 111 determines that the HDD protection setting is set to ON as a result of the determination at step S104 (Yes of step S104), then, the CPU 111 determines whether or not the acceleration detected at step S103 is equal to or higher the acceleration corresponding to the set sensitivity level (step S105). On the other hand, when the CPU ill determines that the HDD protection setting is not set to ON as a result of the determination at step S104 (No of step S104), the process shifts to step S107.

When the CPU 111 determines that the detected acceleration is equal to or higher than the acceleration corresponding to the set sensitivity level as a result of the determination at step S105 (Yes of step S105), the HDD protection processing is executed based on the HDD protection setting (step S106) . On the other hand, when the CPU 111 determines that the detected acceleration is not equal to or higher than the acceleration corresponding to the set sensitivity level as a result of the determination at step S105 (No of step S105), the process shifts to step S107.

Then, the CPU 111 determines whether the setting of the HDD protection setting of the HDD(2) 116 is set to ON or not (step S107). When the CPU 111 determines that the HDD protection setting is set to ON as a result of the determination at step S107 (Yes of step S107), then, the CPU 111 determines whether or not the acceleration detected at step S103 is equal to or higher than the acceleration corresponding to the set sensitivity level (step S108). On the other hand, when the CPU 111 determines that the HDD protection setting is not set to ON as a result of the determination at step S107 (No of step S107), the process shifts to step S103.

When the CPU 111 determines that the detected acceleration is equal to or higher than the acceleration corresponding to the set sensitivity level as a result of the determination at step S108 (Yes of step S108), the HDD protection processing is executed based on the HDD protection setting (step S109). On the other hand, when the CPU 111 determines that the detected acceleration is not equal to or higher than the acceleration corresponding to the set sensitivity level as a result of the determination at step S108 (No of step S108), the process shifts to step S103. This ends the HDD protection processing.

According to the present embodiment structured as described above, by setting whether to execute the HDD protection processing or not for each individual HDD in the computer 10 provided with a plurality of HDDs, convenience of the computer 10 can be improved. For example, for one HDD, the disk protection function is set to operative (the HDD protection processing is executed), and for the other HDD, the disk protection function is set to inoperative (the HDD protection processing is not executed). Even in a use condition where vibration is constantly detected such as when the computer 10 is carried for mobile use, reading and writing of the HDD for which the disk protection function is made operative are stopped, whereas reading and writing of the HDD for which the disk protection function is made inoperative are continued. Therefore, when playback of music data or the like is performed, listening is not stopped and this improves the convenience of the computer.

Moreover, by storing a backup of the data stored in the HDD for which the disk protection function is made inoperative, in the HDD for which the function is made operative, even if the data on the HDD for which the function is made inoperative is broken, no data loss occurs.

Moreover, the setting of ON/OFF of the HDD protection processing is based on setting by the user in the above description, the present invention is not limited thereto. For example, setting maybe switched according to whether the display unit 12 of the computer 10 is in the open position or in the closed position. That is, when the display unit 12 is in the closed position, since it is highly likely that the computer 10 is carried for mobile use, for one HDD, the HDD protection processing is set to ON and for the other HDD, the HDD protection processing is set to OFF. Moreover, when the display unit 12 is in the open position, since it is highly likely that the computer 10 is used on a desk, for both HDDs, the HDD protection processing is set to OFF.

Moreover, the setting of ON/OFF of the HDD protection processing may be associated with the driving condition of the computer 10. That is, when the computer 10 is driven on the battery 112, since it is highly likely that the computer 10 is carried for mobile use, for one HDD, the HDD protection processing set to ON, and for the other HDD, the HDD protection processing is set to OFF. When the computer 10 is driven by the commercial power through the AC adapter 123, since it is highly likely that the computer 10 is used on a desk, for both HDDs, the HDD protection processing is set to OFF.

While the disk protection function of one HDD is made operative and the disk protection function of the other disk is made inoperative in the above description, the present invention is not limited thereto. For example, a mode may be adopted in which the disk protection function is set to operative for both HDDs and the sensitivity levels are set to different levels. According to this mode, when an acceleration equal to or higher than the acceleration corresponding to the lower sensitivity level is detected, the HDD protection processing is executed on only the HDD for which the sensitivity level is set. On the other hand, when an acceleration equal to or higher than the acceleration corresponding to the higher sensitivity level is detected, since the HDD protection processing is executed on both HDDs, data protection of both HDD is realized.

As described above, by individually setting the disk protection function for a plurality of disk devices, the provision of an information processing apparatus and a disk device control method that improve system safety and user convenience is realized.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main unit;
a first disk device provided in the main unit;
a second disk device provided in the main unit;
an acceleration sensor provided in the main unit and detecting an acceleration;
a setting module configured to set whether to execute a disk protection processing for at least one of the first disk device and the second disk device or not; and
a controller configured to execute the processing on the disk device for which the execution of the processing is set by the setting module, when an acceleration is detected by the acceleration sensor.

2. The information processing apparatus according to claim 1, wherein:
the setting module sets a first acceleration for when the processing is executed; and
the controller executes the processing when it is determined that a second acceleration detected by the acceleration sensor is equal to or higher than the first acceleration.

3. The information processing apparatus according to claim 2, wherein
the setting module is capable of selecting the first acceleration for when the processing is executed, from among a plurality of accelerations.

4. The information processing apparatus according to claim 1, further comprising:
an output module configured to output a screen for setting whether to execute the processing or not is provided.

5. The information processing apparatus according to claim 1, wherein:
the first disk device and the second disk device each have a disk and a head; and
the controller retracts the head from the disk when the processing is executed.

6. A disk device control method for an information processing apparatus provided with a first disk device and a second disk device, the method comprising:
detecting an acceleration by an acceleration sensor provided in a main unit of the information processing apparatus;
setting whether to execute a disk protection processing for at least one of the first disk device and the second disk device or not; and
executing the disk protection processing on the disk device for which the execution of the processing is set by the setting module when an acceleration is detected by the acceleration sensor.
